(19) United States
(12) Patent Application Publication
(10) Pub. No.: US 2011/0302037 A1
(43) Pub. Date: Dec. 8, 2011

(54) VIRTUAL GOODS HAVING MULTIPLE EXPRESSIONS

(76) Inventor: Drake Sutton-Shearer, Los Angeles, CA (US)

(21) Appl. No.: 12/795,546

(22) Filed: Jun. 7, 2010

(51) Int. Cl. G06Q 30/00

(52) U.S. Cl. 705/14.66; 705/27.1; 705/14.49

(57) ABSTRACT

A given virtual good provided to users within a virtual environment may be expressed in a default state as a primary expression and, responsive to activation, the given virtual good may be expressed as a secondary expression. The primary expression and the secondary expressions may have some advantageous relationship. In some implementations, generic objects may be paired with branded objects such that a primary expression of a given virtual good represents a generic object and a secondary expression of the given virtual good represents a branded object.

### FIELD OF THE INVENTION

The invention relates to providing virtual goods to users within a virtual environment such that a given virtual good is expressed in a default state as a primary expression and, responsive to activation, a secondary expression of the given virtual good is made visible.

### BACKGROUND OF THE INVENTION

Systems and method for providing virtual goods within virtual environments are known. Some virtual goods are “branded” with a brand that corresponds to a real world good or service. Some of these virtual goods include goods that are distributed by the real world brand owner as part of a promotional and/or advertizing effort.

Virtual goods can also be monetized. For example, an entity that “creates” virtual goods may sell the goods to users in a virtual environment. Such entities may include virtual environment providers, virtual environment users (in environments the permit user generated content), and/or other entities. Typically, users may pay for virtual goods for the functionality, appearance, status, and/or other aspects of the goods. Generally, sale of virtual goods have been the primary manner in which virtual goods creators have been able to obtain payment for their virtual goods.

### SUMMARY

One aspect of the invention relates to a system and method for providing virtual goods to users within one or more virtual environments. A given virtual good provided to the users may be expressed in a default state as a primary expression and, responsive to activation, the given virtual good may be expressed as a secondary expression. The primary expression and the secondary expressions may have some advantageous relationship. In some implementations, generic objects may be paired with branded objects such that a primary expression of a given virtual good represents a generic object and a secondary expression of the given virtual good represents a branded object. Examples of pairings between generic, branded, and/or other objects may include racing cars and oil products, flowers and flower shops, pets and pet food, and/or other pairings. In some implementations, users may be offered physical opportunities to purchase or otherwise obtain generic and/or branded objects associated with virtual goods in the real world. According to various implementations, virtual good may be provided to users free-of-charge, however advertisers of branded goods may be charged when the virtual goods are provided, activated, and/or at some other trigger event.

By way of example, a virtual good may have a primary expression that depicts a generic food item (e.g., a piece of pizza). The virtual good may have a secondary expression that depicts a branded beverage complementary to the generic food item (e.g., beer, wine, Coke®, and/or other beverages). As a default, the exemplary virtual good may be expressed with the primary expression representing the generic food item. Upon some activation, the exemplary virtual good may be expressed with the secondary expression representing the branded beverage. This representation of the generic food item with the branded beverage may entice users to purchase the branded beverage. It will be appreciated that this exemplary pairing is not intended to be limiting.

The system may include one or more servers configured to serve information to client computing platforms being used by users. The one or more servers may be configured to execute computer program modules. The computer program modules may include one or more of an environment module, a user module, a user information module, an inventory module, a goods exchange module, a goods module, a secondary expression module, a goods monitoring module, an advertiser billing module, and/or other modules.

The environment module may be configured to provide one or more virtual environments to users via the client computing platforms. As used herein, a “virtual environment” may include a virtual space, one or more interactive, electronic social media, and/or other virtual environments.

The user module may be configured to access and/or manage one or more user profiles associated with users of the system. The user profiles may include, for example, information identifying the player (e.g., a username or handle, a number, an identifier, and/or other identifying information), security login information (e.g., a login code or password), virtual environment specific account information, subscription information, virtual currency account information (e.g., related to currency held in credit for a user), and/or other information related to users.

The user information module may be configured to access and/or manage one or more user profiles associated with user of the system. The user profiles may include, for example, friend information (e.g., information related to friends of a user), virtual environment usage information, demographic information associated with users, interaction history among users in one or more virtual environments and/or other environments, information stated by users, purchase information of users, browsing history of users, and/or other information related to users.

The inventory module may be configured to access and/or manage virtual good inventories. This may include tracking virtual goods associated with users. Such virtual goods may or may not be visible in a virtual environment, in various implementations. This visibility and/or invisibility may be configurable by the user associated with the virtual goods. The virtual goods may include non-physical objects that are expressible within the virtual environment. The virtual goods associated with an individual user may include one or more of virtual clothing, virtual weapons, virtual vehicles, virtual pets, virtual toys, virtual tools, virtual gifts, and/or other virtual goods. The virtual goods associated with an individual may include goods that are visible on a virtual place (e.g., a “wall” on a social network) within the virtual environment. Such virtual goods may or may not enhance the abilities, skills, and/or gameplay of the user with which they are associated. The virtual goods associated with an individual user may include one or more of virtual goods the user is currently using, virtual goods the user is currently carrying, virtual goods the user has access to, and/or other virtual goods associated with the user.

The inventory module may be configured to access and/or manage asset accounts associated with users. The asset accounts may reflect virtual currency owned by or associated with individual users. The asset accounts may reflect real world currency owned by or associated with individual users. The inventory module 124 may be configured to facilitate exchanges of real world currency for virtual currency and/or vice versa.

The goods exchange module may be configure to facilitate exchange of virtual goods. Exchange of virtual goods may be between two or more of users, virtual good vendors, virtual environment providers, third parties, and/or other entities. Exchange of virtual goods may include buying, selling, trading, receiving, giving, promotional distributions, and/or other forms of exchange. The exchanges of virtual goods may include exchanges accomplished within the virtual environment in which the virtual goods are used and/or displayed. The exchanges of virtual goods may include exchanges accomplished outside of the virtual environment in which the virtual goods are used and/or displayed. By way of non-limiting example, goods may be bought, gifted, trades, distributed, and/or otherwise exchanges in a virtual environment that is ancillary to the virtual environment in which the virtual goods are used and/or displayed. The buying and/or selling of virtual goods may include transactions in which real world currency and/or virtual currency changes hands.

The goods module may be configured to express virtual goods within virtual environments. A virtual good may have a default state in which the virtual good is represented as a primary expression. Responsive to some activation of the virtual good, a secondary expression of the virtual good may become visible in the virtual environment. Further description of such activation is provided below. In accordance with various implementations, the secondary expression may become visible and replace the primary expression, become visible along with the primary expression, and/or become visible in another manner.

In some implementations, the primary expression of the virtual good may generically represent a real world good or service. The secondary expression of the virtual good comprises an identification of a real world provider of goods and/or services associated with the real world good. For example, the primary expression and the secondary expression may include a representation of the same real world good and/or service. The secondary expression of the virtual good may comprise a representation of a real world good that is complementary to a real world good and/or service represented by the primary expression. For example, the primary expression may include a first good or service, and the secondary expression may include a second good or service that is different and complementary or related to the first good or service. Tertiary expressions and/or additional expressions are contemplated.

As used herein, the term “expression” (e.g., primary expression, secondary expression, tertiary expression, etc.) may refer to a manifestation of the virtual good within the virtual environment. This may include one or more of a visible manifestation, an auditory manifestation, an impact of the virtual good on other objects or items in the virtual environment, and/or other manifestations. A visible manifestation of a virtual good may include a static image representing the virtual good. A visible manifestation of a virtual good may include one or more video loops or sequences. For example, a video loop or sequence may be played once or in a loop repetitively. A video loop or sequence may be played at the occurrence of triggers (e.g., an avatar approaching to within a threshold distance, a certain action being performed by an avatar or non-player character, a timing interval, and/or other triggers). A visible manifestation of a virtual good may include an object that is movable and/or controllable within the virtual environment. An auditory manifestation of a virtual good may include an auditory sound or set of sounds. An impact of the virtual good on other objects or items in the virtual environment may include impacts that are visual and/or audible in views (and corresponding audio) of the virtual environment. For example, in a virtual space, an expression of a virtual good that represents a real world good or service that would be consumable (e.g., food or beverage) may include an alteration to an avatar of a user that has activated the virtual good looking satisfied (e.g., smiling, with a full belly, and/or other impacts) and/or making sounds indicating satisfaction.

As mentioned, activation of the virtual good may trigger the secondary expression to become visible in the virtual environment. This may include the secondary expression becoming apparent (e.g., visible) in the virtual environment and hiding the primary expression. This may include the secondary expression becoming apparent in the virtual environment along with the primary expression. As the secondary expression becomes apparent in the virtual environment, the primary expression may remain apparent along with the secondary expression. Activation of the virtual good may result in the primary expression and the secondary expression being made apparent in an alternating manner (e.g., the secondary expression, then the primary expression, then the primary and secondary expressions, and/or other sequences). An object (or objects) depicted in the primary expression may be altered and/or remain unchanged as the secondary expression becomes apparent in the virtual environment.

By way of non-limiting example, upon activation of a virtual good, an animation including the secondary expression and/or the primary expression may be included within views of the virtual environment. The animation may show the secondary expression without the primary expression, the secondary expression and the primary expression, and/or may alternate between views of the secondary expression, the primary expression, and/or the primary expression and the secondary expression. Activation of the virtual good may be triggered by selection of the primary expression by a user. Activation of the virtual good may be triggered by use of the first virtual good by a user within the virtual environment. Activation of the virtual good may include clicking on the virtual good, mousing over the virtual good, and/or other activation mechanisms.

The secondary expression module may be configured to obtain secondary expressions associated with virtual goods. For simplicity, virtual goods having a default state in which the same or (similar) primary expression is apparent in the virtual environment may be referred to herein as a “set” of virtual goods. The secondary expression of a virtual good may not be the same for all virtual goods that are in the same set. This may facilitate the advertising distributed to users through the set of virtual goods being adapted based on one or more expression criteria to enhance the value of the distribution. Basing the secondary expression of individual virtual goods in a set of virtual goods on expression criteria may facilitate customization of the advertizing based on one or more of a user owning or using a virtual good, the user or users viewing (or hearing, and/or perceiving in other ways) a virtual good, the good or service depicted in the primary expression for the set of virtual goods, and/or other criteria.

The secondary expression module may be configured to obtain the secondary expression for a virtual good based on the primary expression for the virtual good. This may include obtaining (e.g., receiving, identifying, determining, and/or otherwise obtaining) a secondary expression that corresponds to the primary expression. A secondary expression may correspond to a primary expression if it represents a brand associated with the same good or service as the primary expression, if it represents a brand associated with a good or service that is complementary to the primary expression, and/or if it corresponds with the first expression in other ways. The secondary expression may be obtained from a group of secondary expressions available generally in the virtual environment, a group of secondary expression available for a specific set of virtual goods, and/or other groups of secondary expressions.

The secondary expression module may be configured to obtain a secondary expression for a virtual good based on user information related to a user associated with the virtual good. The association of the virtual good with the user may be reflected by the user inventory for the user accessed and/or maintained by the inventory module. The secondary expression module may be configured to obtain a secondary expression for a virtual good based on user information related to a user viewing the virtual good in the virtual environment. The user information may include information stored in a user profile associated with the user. The user profile may be maintained and/or accessed by the user information module. The user information may include one or more of demographic information (e.g., age, sex, location, and/or other demographic information), purchase history information, information related to activity within the virtual environment, preferences, and/or other user information. The secondary expression module may be configured to obtain a secondary expression for the virtual good that will represent a brand likely to appeal to the user. The secondary expression module may be configured to obtain a secondary expression for the virtual good that will represent a brand targeting users associated with user information similar to or the same as the user (e.g., an age, a sex, a location, a past purchase history, a preference, and/or other information).

The secondary expression module may be configured to obtain a secondary expression for a virtual good based on received user selection. The user selection may be received from a creator or distributor of the virtual good, a user giving the virtual good in an exchange, a user receiving the virtual good in an exchange, a user associated with the virtual good, a user representing a brand having one or more secondary expressions, and/or other users. The received user selections may include an identity of a single secondary expression, a set of secondary expressions from which to select, the manner in which other expression criteria (e.g., user information, the primary expression, and/or other expression criteria) impact determination of a secondary expression for a primary expression, and/or other expression criteria.

The secondary expression module may be configured to obtain a secondary expression for a virtual good based on a purchase of the secondary expression of the virtual good by an advertiser. The purchase may occur at the end of an auction. The auction may be provided to a group of advertisers by the secondary expression module. The group of advertisers may be presented with the opportunity to bid on one or more primary expressions (e.g., of different virtual goods, of different instances of the same virtual good, and/or other primary expressions). Presentation of the opportunity to bid may include information about the one or more primary expressions. Such information may include, for example, appearance, functionality, ownership (e.g., which users own the virtual good(s)), location/position within a virtual environment, size, average number of viewers per unit of time, and/or other information related to the one or more primary expressions. The information may include partial secondary expressions (to be supplemented with content from the winning bidder). The secondary expression module may be configured to receive bids from the advertisers, and may award the primary expressions to the bid that is the best, the most valuable, and/or the most desirable to the party selling the primary expressions. The auction may conducted through electronic communication with the advertisers. For example, one or more of electronic mail, SMS text messaging, instant messaging, a dedicated messaging media, a website having information related to the auction available thereon, and/or other electronic communication media may be implemented to conduct the auction.

The secondary expression module may be configured to obtain a secondary expression for a virtual good at various points in time. For example, the secondary expression module may be configured to obtain a secondary expression for a virtual good when the virtual good is created or designed, when the virtual good is first distributed, at exchanges between users of the virtual good, at individual viewings of the virtual good, at individual uses of the virtual good, at individual activations of the virtual good, and/or at other times.

The goods monitoring module may be configured to monitor aspects of the expression of virtual goods in the virtual environment. The monitored aspects of the expression of the virtual goods in the virtual environment may include aspects that quantify interaction of users with the secondary expressions of the virtual goods. For example, for a given virtual good, the goods monitoring module may be configured to monitor a number of times the virtual good is activated, a number of times a secondary expression is viewed, the users (and/or a number of users) that have viewed a secondary expression, the users (and/or a number of users) that have selected a secondary expression (e.g., to access information associated with the brand of the secondary expression, such as selecting a link), the users (and/or a number of users) that have made purchases after selecting a secondary expression (e.g., after clicking a link associated with the secondary expression), and/or other aspects of the expression of the virtual good in the virtual environment.

The advertiser billing module may be configured to determine an amount of money owed by an advertiser. The advertiser may owe money based on the presentation of one or more secondary expressions to users in the virtual environment. The amount of money may be determined based on the aspects of the secondary expression(s) monitored by the goods monitoring module (e.g., as described above). The advertiser may be charged, for example, for views of a secondary expression, for selections of a secondary expression, for purchases made after a selection of a secondary expression, and/or for other interactions with secondary expressions.

The advertiser billing module may be configured to bill and/or collect payment from advertisers. This may include, for example, debiting an account of an advertiser, sending an electronic bill to the advertiser, initiating transmission of a traditional bill to the advertiser, and/or other mechanisms for billing and/or collecting payment.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to provide virtual goods to users within one or more virtual environments, according to one or more implementations of the invention.

FIG. 2 illustrates a method of providing virtual goods to users within one or more virtual environments, according to one or more implementations of the invention.

### DETAILED DESCRIPTION

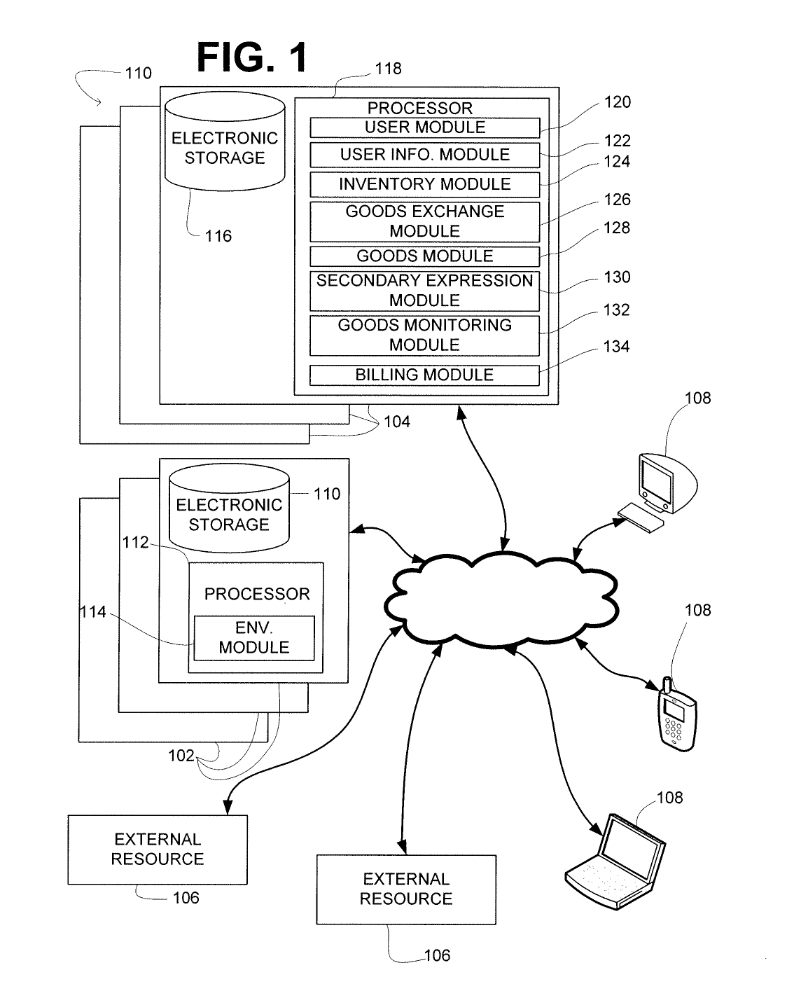

FIG. 1 illustrates a system 100 configured to provide virtual goods to users within one or more virtual environments, according to one or more implementations of the invention. More specifically, a given virtual good provided to the users may be expressed in a default state as a primary expression and, responsive to activation, the given virtual good is expressed as a secondary expression. The primary expression and the secondary expressions may have some advantageous relationship. In some implementations, generic objects may be paired with branded objects such that a primary expression of a given virtual good represents a generic object and a secondary expression of the given virtual good represents a branded object. Examples of pairings between generic, branded, and/or other objects may include racing cars and oil products, flowers and flower shops, pets and pet food, and/or other pairings. In some implementations, users may be offered physical opportunities to purchase or otherwise obtain generic and/or branded objects associated with virtual goods in the real world. According to various implementations, virtual good may be provided to users free-of-charge, however advertisers of branded goods may be charged when the virtual goods are provided, activated, and/or at some other trigger event.

In some implementations, system 100 may include one or more of one or more virtual environment servers 102, one or more system servers 104, and/or other components. The system 100 may operate in communication and/or coordination with one or more external resources 106. Users may interface with system 100 and/or external resources 106 via client computing platforms 108. The components of system 100, virtual environment servers 102, system servers 104, external resources 106, and/or client computing platforms 108 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which virtual environment servers 102, system servers 104, external resources 106, and/or client computing platforms 108 are operatively linked via some other communication media.

A given client computing platform 108 may include one or more processors configured to execute computer program modules. The computer program modules may be configured to enable one or more users associated with the given client computing platform 108 to interface with system 100 and/or external resources 106, and/or provide other functionality attributed herein to client computing platforms 108. By way of non-limiting example, the given client computing platform 108 may include one or more of a desktop computer, a laptop computer, a handheld computer, a NetBook, a Smartphone, and/or other computing platforms.

The external resources 106 may include sources of information, hosts and/or providers of virtual environments outside of system 100, external entities participating with system 100, and/or other resources. In some implementations, some or all of the functionality attributed herein to external resources 106 may be provided by resources included in system 100.

The virtual environment servers 102 may comprise electronic storage 110, one or more processors 112, and/or other components. The virtual environment servers 102 may include communication lines, or ports to enable the exchange of information with a network and/or other computing platforms. The processors 112 may be configured to execute computer program modules. The processors 112 may be configured to execute the computer program modules via one or more of hardware, software, and/or firmware. The computer program modules may include an environment module 114, and/or other computer program modules. Although system 100 may be described in certain sections herein as including virtual environment servers 102, this is not intended to be limiting. The virtual environment servers 102 may be separate and distinct from system 100, and may be provided by an entity that is separate from, for example, the entity providing system servers 104.

The environment module 114 may be configured to provide one or more virtual environments to users via client computing platforms 108. As used herein, a “virtual environment” may include a virtual space, one or more interactive, electronic social media, and/or other virtual environments.

A virtual space may comprise a simulated space (e.g., a physical space) instanced on a server (e.g., virtual environment servers 102) that is accessible by a client (e.g., client computing platforms 108) located remotely from the server to format a view of the virtual space for display to a user. The simulated space may have a topography, express ongoing real-time interaction by the user, and/or include one or more objects positioned within the topography that are capable of locomotion within the topography. In some instances, the topography may be a 2-dimensional topography. In other instances, the topography may be a 3-dimensional topography. The topography may include dimensions of the virtual space, and/or surface features of a surface or objects that are “native” to the virtual space. In some instances, the topography may describe a surface (e.g., a ground surface) that runs through at least a substantial portion of the virtual space. In some instances, the topography may describe a volume with one or more bodies positioned therein (e.g., a simulation of gravity-deprived space with one or more celestial bodies positioned therein). A virtual space may include a virtual world, but this is not necessarily the case. For example, a virtual space may include a game space that does not include one or more of the aspects generally associated with a virtual world (e.g., gravity, a landscape, etc.).

Within a virtual space provided by virtual environment servers 102, avatars associated with the users may be controlled by the users to interact with each other. As used herein, the term “avatar” may refer to an object (or group of objects) present in the virtual space that represents an individual user. The avatar may be controlled by the user with which it is associated. The avatars may interact with each other by physical interaction within the instanced virtual space, through text chat, through voice chat, and/or through other interactions. The avatar associated with a given user may be created and/or customized by the given user. The avatar may be associated with an “inventory” of virtual goods and/or currency that the user can use (e.g., by manipulation of the avatar and/or the items) within the virtual space.

Virtual goods may be non-physical objects that can be purchased for use in online communities, online games, virtual worlds, and other virtual spaces. Virtual goods may include, for example, such things as digital gifts, digital clothing for avatars, virtual real estate, and/or any other virtual item. Virtual goods may be classified as services (i.e., virtual services) instead of goods. Sales of virtual goods may be referred to as microtransactions.

Interactive, electronic social media may include one or more of a social network, a virtual space, a micro-blogging service, a blog service (or host), a browser-based game, a multi-player mobile game, a file (e.g., image file, video file, and/or other files) sharing service, a messaging service, a message board, a forum, and/or other electronically distributed media that are scalable and enable interaction between the users. Some non-limiting specific examples of interactive, electronic social media may include the micro-blogging service provided by Twitter™, the social network provided by Facebook™, the social network provided by MySpace™, the virtual world provided by SecondLife®, the virtual world building and hosting service provided by Metaplace®, the massively multi-player online game provided by World of Warcraft®, the file sharing service provided by Flickr®, Blogger, YouTube, PlayStation® Home, Xbox® Live, and/or other interactive electronic social media.

The system servers 104 may include electronic storage 116, one or more processors 118, and/or other components. The system servers 104 may include communication lines, or ports to enable the exchange of information with a network and/or other computing platforms. It will be appreciated that the illustration of virtual environment servers 102 and system servers 104 as two separate sets of devices is not intended to be limiting. In some implementations, virtual environment servers 102 and system servers 104 may include at least one device in common that performs some or all of the functionality attributed herein to virtual environment servers 102 and some or all of the functionality attributed herein to system servers 104.

Electronic storage 116 may comprise electronic storage media that electronically stores information. The electronic storage media of electronic storage 116 may include one or both of system storage that is provided integrally (i.e., substantially non-removable) with system servers 104 and/or removable storage that is removably connectable to system servers 104 via, for example, a port (e.g., a USB port, a firewire port, etc.) or a drive (e.g., a disk drive, etc.). Electronic storage 116 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 116 may store software algorithms, information determined by processor 118, information received from system servers 104, information received from client computing platforms 108, information received from virtual environment servers 102, and/or other information that enables system servers 104 to function properly.

Processor(s) 118 is configured to provide information processing capabilities in system servers 104. As such, processor 118 may include one or more of a digital processor, an analog processor, a digital circuit designed to process information, an analog circuit designed to process information, a state machine, and/or other mechanisms for electronically processing information. Although processor 118 is shown in FIG. 1 as a single entity, this is for illustrative purposes only. In some implementations, processor 118 may include a plurality of processing units. These processing units may be physically located within the same device, or processor 118 may represent processing functionality of a plurality of devices operating in coordination.

As is shown in FIG. 1, processor 118 may be configured to execute one or more computer program modules. The one or more computer program modules may include one or more of a user module 120, a user information module 122, an inventory module 124, a goods exchange module 126, a goods module 128, a secondary expression module 130, a goods monitoring module 132, an advertiser billing module 134, and/or other modules. Processor 118 may be configured to execute modules 120, 122, 124, 126, 128, 130, 132, and/or 134 by software; hardware; firmware; some combination of software, hardware, and/or firmware; and/or other mechanisms for configuring processing capabilities on processor 118.

It should be appreciated that although modules 120, 122, 124, 126, 128, 130, 132, and 134 are illustrated in FIG. 1 as being co-located within a single processing unit, in implementations in which processor 118 includes multiple processing units, one or more of modules 120, 122, 124, 126, 128, 130, 132, and/or 134 may be located remotely from the other modules. In implementations in which system servers 104 and virtual environment servers 102 operate in a coordinated manner to provide the functionality described herein with respect to processor 118, some or all of the functionality attributed to one or more of 120, 122, 124, 126, 128, 130, 132, and/or 134 may be provided by the modules executed on processors 112 of virtual environment servers 102. The description of the functionality provided by the different modules 120, 122, 124, 126, 128, 130, 132, and/or 134 described below is for illustrative purposes, and is not intended to be limiting, as any of modules 120, 122, 124, 126, 128, 130, 132, and/or 134 may provide more or less functionality than is described. For example, one or more of modules 120, 122, 124, 126, 128, 130, 132, and/or 134 may be eliminated, and some or all of its functionality may be provided by other ones of modules 120, 122, 124, 126, 128, 130, 132, and/or 134. As another example, processor 118 may be configured to execute one or more additional modules that may perform some or all of the functionality attributed below to one of modules 120, 122, 124, 126, 128, 130, 132, and/or 134.

The user module 120 may be configured to access and/or manage one or more user profiles associated with users of the system 100. The one or more user profiles may include information stored by electronic storage 110, electronic storage 116, one or more of the client computing platforms 108, and/or other storage locations. The user profiles may include, for example, information identifying the player (e.g., a username or handle, a number, an identifier, and/or other identifying information), security login information (e.g., a login code or password), virtual environment specific account information, subscription information, virtual currency account information (e.g., related to currency held in credit for a user), and/or other information related to users.

The user information module 122 may be configured to access and/or manage one or more user profiles associated with user of the system 100. The one or more user profiles may include information stored by electronic storage 110, electronic storage 116, one or more of the client computing platforms 108, and/or other storage locations. The user profiles may include, for example, friend information (e.g., information related to friends of a user), virtual environment usage information, demographic information associated with users, interaction history among users in one or more virtual environments and/or other environments, information stated by users, purchase information of users, browsing history of users, and/or other information related to users.

The inventory module 124 may be configured to access and/or manage virtual good inventories. This may include tracking virtual goods associated with users. Such virtual goods may or may not be visible in a virtual environment, in various implementations. This visibility and/or invisibility may be configurable by the user associated with the virtual goods. The virtual goods may include non-physical objects that are expressible within the virtual environment. The virtual goods associated with an individual user may include one or more of virtual clothing, virtual weapons, virtual vehicles, virtual pets, virtual toys, virtual tools, virtual gifts, and/or other virtual goods. The virtual goods associated with an individual may include goods that are visible on a virtual place (e.g., a “wall” on a social network) within the virtual environment. Such virtual goods may or may not enhance the abilities, skills, and/or gameplay of the user with which they are associated. The virtual goods associated with an individual user may include one or more of virtual goods the user is currently using, virtual goods the user is currently carrying, virtual goods the user has access to, and/or other virtual goods associated with the user.

The inventory module 124 may be configured to access and/or manage asset accounts associated with users. The asset accounts may reflect virtual currency owned by or associated with individual users. The asset accounts may reflect real world currency owned by or associated with individual users. The inventory module 124 may be configured to facilitate exchanges of real world currency for virtual currency and/or vice versa.

The goods exchange module 126 may be configure to facilitate exchange of virtual goods. Exchange of virtual goods may be between two or more of users, virtual good vendors, virtual environment providers, third parties, and/or other entities. Exchange of virtual goods may include buying, selling, trading, receiving, giving, promotional distributions, and/or other forms of exchange. The exchanges of virtual goods may include exchanges accomplished within the virtual environment in which the virtual goods are used and/or displayed. The exchanges of virtual goods may include exchanges accomplished outside of the virtual environment in which the virtual goods are used and/or displayed. By way of non-limiting example, goods may be bought, gifted, trades, distributed, and/or otherwise exchanges in a virtual environment that is ancillary to the virtual environment in which the virtual goods are used and/or displayed. The buying and/or selling of virtual goods may include transactions in which real world currency and/or virtual currency changes hands.

The goods module 128 may be configured to express virtual goods within virtual environments. A virtual good may have a default state in which the virtual good is represented as a primary expression. Responsive to some activation of the virtual good, a secondary expression of the virtual good may become visible in the virtual environment. Further description of such activation is provided below. In accordance with various implementations, the secondary expression may become visible and replace the primary expression, become visible along with the primary expression, and/or become visible in another manner.

In some implementations, the primary expression of the virtual good may generically represent a real world good or service. The secondary expression of the virtual good comprises an identification of a real world provider of goods and/or services associated with the real world good or service. For example, the primary expression and the secondary expression of the virtual good may comprise a representation of the same real world good or service. The representation in the secondary expression may be the same as the primary expression and/or may represent the common good or service differently. The secondary expression of the virtual good may comprise a representation of a real world good or service that is complementary to a real world good or service represented by the primary expression. For example, the primary expression may include a first good or service, and the secondary expression may include a second good or service that is different and complementary or related to the first good or service. Tertiary expressions and/or additional expressions' are contemplated.

As used herein, the term “expression” (e.g., primary expression, secondary expression, tertiary expression, etc.) may refer to a manifestation of the virtual good within the virtual environment. This may include one or more of a visible manifestation, an auditory manifestation, an impact of the virtual good on other objects or items in the virtual environment, and/or other manifestations. A visible manifestation of a virtual good may include a static image representing the virtual good. A visible manifestation of a virtual good may include one or more video loops or sequences. For example, a video loop or sequence may be played once or in a loop repetitively. A video loop or sequence may be played at the occurrence of triggers (e.g., an avatar approaching to within a threshold distance, a certain action being performed by an avatar or non-player character, a timing interval, and/or other triggers). A visible manifestation of a virtual good may include an object that is movable and/or controllable within the virtual environment. An auditory manifestation of a virtual good may include an auditory sound or set of sounds. An impact of the virtual good on other objects or items in the virtual environment may include impacts that are visual and/or audible in views (and corresponding audio) of the virtual environment. For example, in a virtual space, an expression of a virtual good that represents a real world good or service that would be consumable (e.g., food or beverage) may include an alteration to an avatar of a user that has activated the virtual good looking satisfied (e.g., smiling, with a full belly, and/or other impacts) and/or making sounds indicating satisfaction). The expression of the virtual good may provide an item or object with abilities or skills it does not have if the expression is not apparent.

As mentioned, activation of the virtual good may trigger the secondary expression to become visible in the virtual environment. This may include the secondary expression becoming apparent (e.g., visible) in the virtual environment and hiding the primary expression. This may include the secondary expression becoming apparent in the virtual environment along with the primary expression. As the secondary expression becomes apparent in the virtual environment, the primary expression may remain apparent along with the secondary expression. Activation of the virtual good may result in the primary expression and the secondary expression being made apparent in an alternating manner (e.g., the secondary expression, then the primary expression, then the primary and secondary expressions, and/or other sequences). An object (or objects) depicted in the primary expression may be altered and/or remain unchanged as the secondary expression becomes apparent in the virtual environment.

By way of non-limiting example, upon activation of a virtual good, an animation including the secondary expression and/or the primary expression may be included within views of the virtual environment. The animation may show the secondary expression without the primary expression, the secondary expression and the primary expression, and/or may alternate between views of the secondary expression, the primary expression, and/or the primary expression and the secondary expression. Activation of the virtual good may be triggered by selection of the primary expression by a user. Activation of the virtual good may be triggered by use of the first virtual good by a user within the virtual environment. Activation of the virtual good may include clicking on the virtual good, mousing over the virtual good, and/or other activation mechanisms.

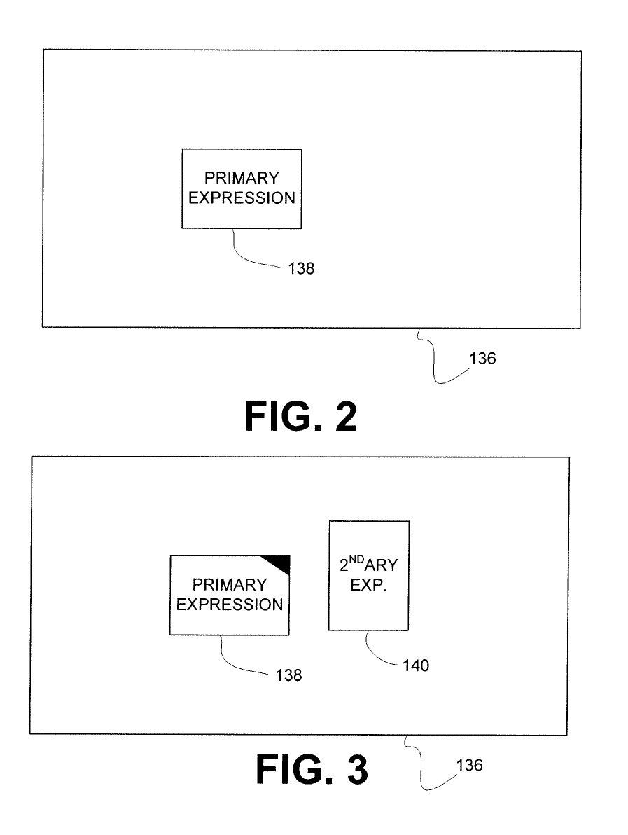

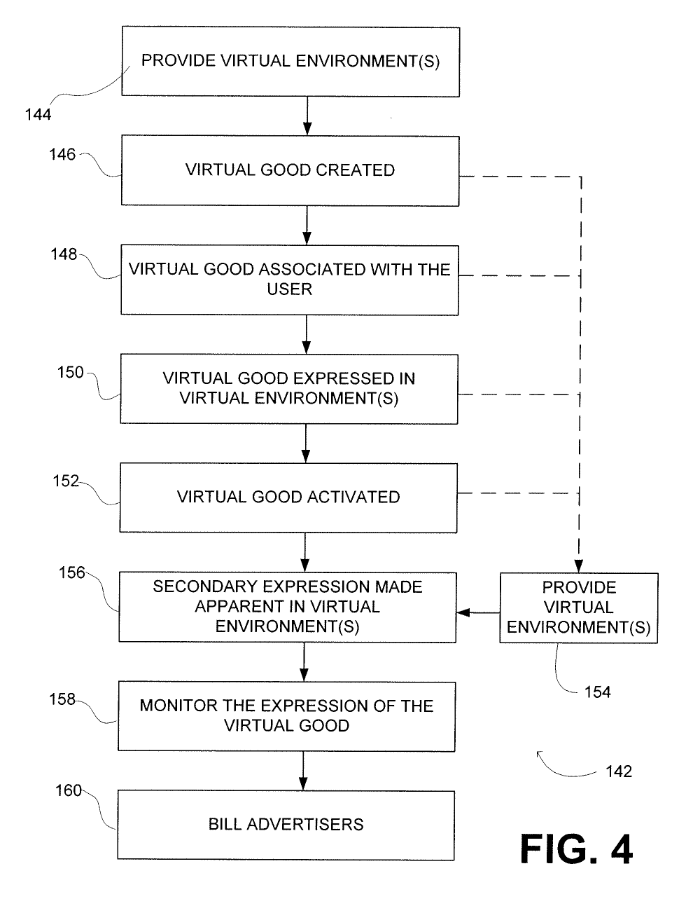

By way of illustration, FIG. 2 illustrates a view 136 of a virtual environment provided to a user. The view 136 includes a primary expression 138 of a virtual good. The primary expression 138 may be the default state of the virtual good. For example, primary expression 138 may include an edible item, such as pizza, a hamburger, a hotdog, a plate of pasta, and/or other edible items.

Upon activation of the virtual good, the state of the virtual good may change from the default state. For example, referring to FIG. 3, the activation of the virtual good may cause a secondary expression 140 of the virtual good to become visible within the virtual environment. The secondary expression 140 may be branded. For example, secondary expression 140 may be branded with a brand associated directly with the object shown in primary expression 138. Such a brand may include a brand of an entity that provides the good and/or service depicted in primary expression 138. The secondary expression 140 may be branded with a brand associated with a good or service that is complementary to secondary expression 140. For example, if primary expression 138 includes an edible item, secondary expression 140 may include a brand associated with a beverage considered to be complementary to the edible item of primary expression 138.

As is shown in FIG. 3, secondary expression 140 may be visible in view 136 along with primary expression 138. The depiction of primary expression 138 may be altered (e.g., in time step or through animation) upon activation. For example, if primary expression 138 includes an edible item, activation of the virtual good may result in bites of the edible item disappearing or being taken. The illustration of primary expression 138 along with secondary expression 140 in view 136 is not intended to be limiting. Activation of the virtual good may result in secondary expression 140 being visible in view 136 and primary expression 138 not being visible.

It will be appreciated that the description of primary expression 138 and secondary expression 140 as being representing a food and beverage, respectively, is not intended to be limiting. Other implementations in which primary expression 138 and/or secondary expression 140 represent other goods and/or services exist.

Referring back to FIG. 1, the secondary expression module 130 may be configured to obtain secondary expressions associated with virtual goods. For simplicity, virtual goods having a default state in which the same or (similar) primary expression is apparent in the virtual environment may be referred to herein as a “set” of virtual goods. The secondary expression of a virtual good may not be the same for all virtual goods that are in the same set. This may facilitate the advertising distributed to users through the set of virtual goods being adapted based on one or more expression criteria to enhance the value of the distribution. Basing the secondary expression of individual virtual goods in a set of virtual goods on expression criteria may facilitate customization of the advertizing based on one or more of a user owning or using a virtual good, the user or users viewing (or hearing, and/or perceiving in other ways) a virtual good, the good or service depicted in the primary expression for the set of virtual goods, and/or other criteria.

The secondary expression module 130 may be configured to obtain the secondary expression for a virtual good based on the primary expression for the virtual good. This may include obtaining (e.g., receiving, identifying, determining, and/or otherwise obtaining) a secondary expression that corresponds to the primary expression. A secondary expression may correspond to a primary expression if it represents a brand associated with the same good or service as the primary expression, if it represents a brand associated with a good or service that is complementary to the primary expression, and/or if it corresponds with the first expression in other ways. The secondary expression may be obtained from a group of secondary expressions available generally in the virtual environment, a group of secondary expression available for a specific set of virtual goods, and/or other groups of secondary expressions.

The secondary expression module 130 may be configured to obtain a secondary expression for a virtual good based on user information related to a user associated with the virtual good. The association of the virtual good with the user may be reflected by the user inventory for the user accessed and/or maintained by inventory module 124. The secondary expression module 130 may be configured to obtain a secondary expression for a virtual good based on user information related to a user viewing the virtual good in the virtual environment. The user information may include information stored in a user profile associated with the user. The user profile may be maintained and/or accessed by user information module 122. The user information may include one or more of demographic information (e.g., age, sex, location, and/or other demographic information), purchase history information, information related to activity within the virtual environment, preferences, and/or other user information. The secondary expression module 130 may be configured to obtain a secondary expression for the virtual good that will represent a brand likely to appeal to the user. The secondary expression module 130 may be configured to obtain a secondary expression for the virtual good that will represent a brand targeting users associated with user information similar to or the same as the user (e.g., an age, a sex, a location, a past purchase history, a preference, and/or other information).

The secondary expression module 130 may be configured to obtain a secondary expression for a virtual good based on received user selection. The user selection may be received from a creator or distributor of the virtual good, a user giving the virtual good in an exchange, a user receiving the virtual good in an exchange, a user associated with the virtual good, a user representing a brand having one or more secondary expressions, and/or other users. The received user selections may include an identity of a single secondary expression, a set of secondary expressions from which to select, the manner in which other expression criteria (e.g., user information, the primary expression, and/or other expression criteria) impact determination of a secondary expression for a primary expression, and/or other expression criteria.

The secondary expression module 130 may be configured to obtain a secondary expression for a virtual good based on a purchase of the secondary expression of the virtual good by an advertiser. The purchase may occur at the end of an auction. The auction may be provided to a group of advertisers by secondary expression module 130. The group of advertisers may be presented with the opportunity to bid on one or more primary expressions (e.g., of different virtual goods, of different instances of the same virtual good, and/or other primary expressions). Presentation of the opportunity to bid may include information about the one or more primary expressions. Such information may include, for example, appearance, functionality, ownership (e.g., which users own the virtual good(s)), location/position within a virtual environment, size, average number of viewers per unit of time, and/or other information related to the one or more primary expressions. The information may include partial secondary expressions (to be supplemented with content from the winning bidder). The secondary expression module 130 may be configured to receive bids from the advertisers, and may award the primary expressions to the bid that is the best, the most valuable, and/or the most desirable to the party selling the primary expressions. The auction may conducted through electronic communication with the advertisers. For example, one or more of electronic mail, SMS text messaging, instant messaging, a dedicated messaging media, a website having information related to the auction available thereon, and/or other electronic communication media may be implemented to conduct the auction.

The secondary expression module 130 may be configured to obtain a secondary expression for a virtual good at various points in time. For example, secondary expression module 130 may be configured to obtain a secondary expression for a virtual good when the virtual good is created or designed, when the virtual good is first distributed, at exchanges between users of the virtual good, at individual viewings of the virtual good, at individual uses of the virtual good, at individual activations of the virtual good, and/or at other times.

The goods monitoring module 132 may be configured to monitor aspects of the expression of virtual goods in the virtual environment. The monitored aspects of the expression of the virtual goods in the virtual environment may include aspects that quantify interaction of users with the secondary expressions of the virtual goods. For example, for a given virtual good, goods monitoring module 132 may be configured to monitor a number of times the virtual good is activated, a number of times a secondary expression is viewed, the users (and/or a number of users) that have viewed a secondary expression, the users (and/or a number of users) that have selected a secondary expression (e.g., to access information associated with the brand of the secondary expression, such as selecting a link), the users (and/or a number of users) that have made purchases after selecting a secondary expression (e.g., after clicking a link associated with the secondary expression), and/or other aspects of the expression of the virtual good in the virtual environment.

The advertiser billing module 134 may be configured to determine an amount of money owed by an advertiser. The advertiser may owe money based on the presentation of one or more secondary expressions to users in the virtual environment. The amount of money may be determined based on the aspects of the secondary expression(s) monitored by goods monitoring module 132 (e.g., as described above). The advertiser may be charged, for example, for views of a secondary expression, for selections of a secondary expression, for purchases made after a selection of a secondary expression, and/or for other interactions with secondary expressions.

The advertiser billing module 134 may be configured to bill and/or collect payment from advertisers. This may include, for example, debiting an account of an advertiser, sending an electronic bill to the advertiser, initiating transmission of a traditional bill to the advertiser, and/or other mechanisms for billing and/or collecting payment.

FIG. 4 illustrates a method 142 of providing virtual goods to users within a virtual environment. The operations of method 142 presented below are intended to be illustrative. In some implementations, method 142 may be accomplished with one or more additional operations not described, and/or without one or more of the operations discussed. Additionally, the order in which the operations of method 142 are illustrated in FIG. 4 and described below is not intended to be limiting.

In some implementations, method 142 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 41420 in response to instructions stored electronically on an electronic storage medium. The one or more processing devices may include one or more devices configured through hardware, firmware, and/or software to be specifically designed for execution of one or more of the operations of method 142.

At an operation 144, a virtual environment may be provided to users such that the users are presented with views of the virtual environment. In some implementations, operation 144 may be performed by an environment module similar to or the same as environment module 114 (shown in FIG. 1 and described above).

At an operation 146, a virtual good may be created. This may include receiving user selections that result in the creation of the virtual good, receiving an upload of the virtual good, and/or other receiving other inputs resulting in the creation of the virtual good. In some implementations, operation 146 may be performed by a goods module similar to or the same as goods module 128 (shown in FIG. 1 and described above).

At an operation 148, the virtual good may be associated with a user. Associating the virtual good with the user may be the result of an exchange of a virtual good. The exchange may include a purchase, a sale, a trade, a gifting, and/or other exchanges. Association of the virtual good with the user may be accomplished by including the virtual good in an inventory associated with the user. In some implementations, operation 148 may be accomplished by an inventory module and/or a goods exchange module similar to or the same as inventory module 124 and/or goods exchange module 126, respectively (shown in FIG. 1 and described above).

At an operation 150, the virtual good may be expressed in the virtual environment. Expressing the virtual good in the virtual environment may include making a primary and/or a secondary expression of the virtual good apparent in the virtual environment. The default state of the virtual good may include making the primary expression of the virtual good apparent in the virtual environment. The primary expression may depict a good or service (e.g., a real world good or service). In some implementations, operation 150 may be performed by a goods module similar to or the same as goods module 128 (shown in FIG. 1 and described above).

At an operation 152, the virtual good may be activated in the virtual environment. The activation of the virtual good may be in response to a trigger. The trigger may include user action, non-player character action, a timing interval, and/or other triggers. In some implementations, operation 152 may be performed by a goods module similar to or the same as goods module 128 (shown in FIG. 1 and described above).

At an operation 154, the secondary expression of the virtual good may be obtained. The secondary expression may be branded with a brand that corresponds to the good and/or service represented by the primary expression of the virtual good. Operation 154 may be performed at or responsive to one or more of operations 146, 148, 150, and/or 152. In some implementations, operation 154 may be performed by a secondary expression module similar to or the same as secondary expression module 130 (shown in FIG. 1 and described above).

At an operation 156, the secondary expression of the virtual good may be made apparent in the virtual environment in response to operation 152. In some implementations, operation 156 may be performed by a goods module similar to or the same as goods module 128 (shown in FIG. 1 and described above).

At an operation 158, aspects of the expression of the virtual good in the virtual environment may be monitored. Such aspects may include and/or quantify interactions of users with the secondary expression of the virtual good. In some implementations, operation 158 may be performed by a goods monitoring module similar to or the same as goods monitoring module 132 (shown in FIG. 1 and described above).

At an operation 160, one or more advertisers may be billed based on the expression of the virtual good in the virtual environment. This may include determining an amount that the one or more advertisers owe (individually or as a group), and/or obtaining payment from the one or more advertisers. In some implementations, operation 160 may be performed by an advertiser billing module similar to or the same as advertiser billing module 134 (shown in FIG. 1 and described above).

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any implementation can be combined with one or more features of any other implementation.

What is claimed is:

1. A system configured to provide virtual goods to users within a virtual environment, the system comprising:
one or more processors configured to execute computer program modules, the computer program modules comprising:
an environment module configured to provide a virtual environment to a first user such that the first user is presented with views of the virtual environment; and
a goods module configured to express a first virtual good within the virtual environment, wherein in the default state of the first virtual good within the views of the virtual environment the first virtual good is represented as a primary expression of the first virtual good, the goods module being further configured such that responsive to activation of the first virtual good, the secondary expression of the first virtual good becomes visible in the virtual environment to the first user.

2. The system of claim 1, wherein the primary expression of the first virtual good generically represents a first real world good, and wherein the secondary expression of the first virtual good comprises an identification of a real world provider of goods and/or services associated with the first real world good.

3. The system of claim 2, wherein the secondary expression of the first virtual good comprises a representation of the first real world good.

4. The system of claim 2, wherein the secondary expression of the first virtual good comprises a representation of a second real world good that is complementary to the first real world good.

5. The system of claim 1, wherein the goods module is configured such that activation of the first virtual good is triggered by selection of the primary expression by the first user.

6. The system of claim 1, wherein the computer program modules further comprise a secondary expression module configured to determine the secondary expression for the first virtual good.

7. The system of claim 6, wherein the secondary expression module is configured to determine the secondary expression for the first virtual good based on user information related to the first user.

8. The system of claim 6, wherein the secondary expression module is configured to determine the secondary expression for the first virtual good based on user information related to a second user receiving views of the virtual environment that include the first virtual good.

9. The system of claim 1, wherein the computer program modules further comprise a goods monitoring module configured to monitor aspects of the expression of the first virtual good in the virtual environment.

10. The system of claim 1, wherein the monitored aspects of the expression of the first virtual good in the virtual environment include one or more of a number of activations of the first virtual good, interactions by users with the secondary expression of the first virtual good, a number of users that have viewed the primary and/or secondary expressions of the first virtual good, or identities of users that have viewed the primary and/or secondary expressions of the first virtual good.

11. A computer-implemented method of providing virtual goods to users within a virtual environment, the method being implemented in a computer system comprising one or more processors configured to execute computer program modules, the method comprising:
providing a virtual environment to a first user such that the first user is presented with views of the virtual environment; and
expressing a first virtual good within the virtual environment,
wherein in the default state of the first virtual good within the views of the virtual environment the first virtual good is represented as a primary expression of the first virtual good, and
wherein expressing the first virtual good comprises, responsive to activation of the first virtual good, making the secondary expression of the first virtual good visible in the virtual environment to the first user.

12. The method of claim 11 wherein the primary expression of the first virtual good generically represents a first real world good, and wherein the secondary expression of the first virtual good comprises an identification of a real world provider of goods and/or services associated with the first real world good.

13. The method of claim 12, wherein the secondary expression of the first virtual good comprises a representation of the first real world good.

14. The method of claim 12, wherein the secondary expression of the first virtual good comprises a representation of a second real world good that is complementary to the first real world good.

15. The method of claim 11, further comprising determining the secondary expression for the first virtual good based on user information related to the first user.

16. The method of claim 11, further comprising determining the secondary expression for the first virtual good based on user information related to a second user receiving views of the virtual environment that include the first virtual good.

17. The method of claim 11, further comprising determining, responsive to activation of the first virtual good, the secondary expression for the first virtual good.

18. The method of claim 11, further comprising determining the secondary expression for the first virtual good based on user selection.

19. The method of claim 11, further comprising monitoring aspects of the expression of the first virtual good in the virtual environment.

20. The method of claim 19, wherein the monitored aspects of the expression of the first virtual good in the virtual environment include one or more of a number of activations of the first virtual good, interactions by users with the secondary expression of the first virtual good, a number of users that have viewed the primary and/or secondary expressions of the first virtual good, or identities of users that have viewed the primary and/or secondary expressions of the first virtual good.
